(19) United States
(12) Patent Application Publication
(10) Pub. No.: US 2026/0336466 A1
(43) Pub. Date: Oct. 29, 2026

(54) ENHANCED REDUNDANCY IN MIXED-VOLTAGE LOW VOLTAGE SYSTEM

(71) Applicant: Rivian IP Holdings, LLC, Irvine, CA (US)

(72) Inventors: Frederik Francois BOTES, Ontario, CA (US); Ramachandra VANNALA, Fremont, CA (US); Charles John SCANLON, Long Beach, CA (US); Sanjeewa Keven SUGATAPALA, Long Beach, CA (US); Srinivasa Sastry GUNTUR, Charlotte, NC (US)

(21) Appl. No.: 19/192,115

(22) Filed: Apr. 28, 2025

(51) Int. Cl. B60L 58/10; B60L 55/00

(52) U.S. Cl. CPC B60L 58/10; B60L 55/00; B60L 2210/10

(57) ABSTRACT

The subject technology provides for a power conversion architecture having a first power converter configured to receive power from a first power source and supply a first voltage domain, and a second power converter configured to receive power from a second power source and supply a second voltage domain. Each converter delivers power to a respective power path including both a primary load and a redundant load. A third power converter is coupled between the first and second voltage domains and enables bidirectional power transfer in response to fault conditions. This configuration supports fault-tolerant operation in safety-relevant automotive systems, including brake-by-wire, steer-by-wire, and autonomous driving systems, where uninterrupted functionality can be beneficial for maintaining operational safety. By utilizing only three DC-DC converters, the subject technology reduces bill of materials cost, weight, component count, and thermal management overhead. The architecture enables mixed-voltage systems while maintaining compatibility across diverse vehicle platforms.

### INTRODUCTION

This application is directed to power management systems for electric vehicles, such as enhanced redundancy in mixed-voltage low voltage systems.

### SUMMARY

The subject technology provides for a power conversion system including a first power converter supplying a first voltage domain, a second power converter supplying a second, different voltage domain, and a third power converter configured to transfer power between the two domains based on fault conditions. Each voltage domain includes a primary and redundant load. The configuration supports fault-tolerant operation in automotive systems such as brake-by-wire, steer-by-wire, and self-driving platforms, where maintaining functionality during faults is beneficial. By using three DC-DC converters instead of four, the subject technology reduces cost, weight, component count, and thermal management requirements while preserving redundancy. The architecture supports mixed-voltage systems (e.g., 12V and 48V), enabling reduced wiring complexity and adaptability across multiple vehicle platforms without reliance on traditional mechanical subsystems.

### BRIEF DESCRIPTION OF THE DRAWINGS

Certain features of the subject technology are set forth in the appended claims. However, for purpose of explanation, several embodiments of the subject technology are set forth in the following figures.

FIG. 1A illustrates a schematic overhead view of example implementations of a vehicle in accordance with one or more implementations.

FIG. 1B illustrates a schematic side view of example implementations of a vehicle in accordance with one or more implementations.

FIG. 2 illustrates an exemplary block diagram of a power management system that includes multiple power converters in accordance with one or more implementations.

FIG. 3 illustrates an exemplary block diagram of a power management system that includes multiple power converters with enhanced redundancy in accordance with one or more implementations.

FIG. 4 conceptually illustrates an example of a first fault condition in the power management system of FIG. 3 that includes multiple power converters with enhanced redundancy in accordance with one or more implementations.

FIG. 5 conceptually illustrates an example of a second fault condition in the power management system of FIG. 3 that includes multiple power converters with enhanced redundancy in accordance with one or more implementations.

FIG. 6 conceptually illustrates an example of a third fault condition in the power management system of FIG. 3 that includes multiple power converters with enhanced redundancy in accordance with one or more implementations.

FIG. 7 conceptually illustrates an example of a fourth fault condition in the power management system of FIG. 3 that includes multiple power converters with enhanced redundancy in accordance with one or more implementations.

FIG. 8 conceptually illustrates an example of a fifth fault condition in the power management system of FIG. 3 that includes multiple power converters with enhanced redundancy in accordance with one or more implementations.

FIG. 9 conceptually illustrates an example of a load balancing function in the power management system of FIG. 3 that includes multiple power converters with enhanced redundancy in accordance with one or more implementations.

FIG. 10 conceptually illustrates an example of an active balancing function in the power management system of FIG. 3 that includes multiple power converters with enhanced redundancy in accordance with one or more implementations.

FIG. 11 is a flow chart of illustrative operations that may be performed for enhanced redundancy in mixed-voltage low voltage systems in accordance with one or more implementations.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, it will be clear and apparent to those skilled in the art that the subject technology is not limited to the specific details set forth herein and may be practiced without these specific details. In some instances, well-known structures and components are shown in block diagram form in order to avoid obscuring the concepts of the subject technology.

In the automotive sector, brake-by-wire (BBW), steer-by-wire (SBW), and self-driving (SD) systems exhibit safety-critical behavior, where availability of functionality is beneficial for mitigating safety hazards. Shutting down these systems in response to a fault may not align with safety objectives. The power supply to these units can benefit from a high degree of robustness and may incorporate redundancy to prevent a single fault from resulting in the loss of a safety-critical function. This redundancy can increase cost due to the additional components involved. Additionally, the power consumption characteristics of these systems can benefit from higher operating voltages (e.g., 48V) to reduce wire gauge requirements by lowering current draw; however, most other automotive electronics operate at 12V.

In a mixed-voltage low-voltage (LV) system where redundancy can contribute to safety of availability, a configuration utilizing four power converters (e.g., direct current to direct current (DC-DC) converters) can be implemented to achieve the beneficial level of redundancy. In one or more implementations, the number of DC-DC converters in the power conversion stage can be reduced to three instead of four, without reliance on alternative power sources, while maintaining the safety of availability beneficial for BBW, SBW, and SD systems.

Embodiments of the subject technology have competitive advantages that include a lower bill of materials (BOM) cost, reduced weight, fewer components requiring packaging, and decreased thermal management requirements due to the reduction in component count such as is the reduction in the number of DC-DC converters from four to three. BBW, SBW, and SD systems can facilitate more adaptable platform configurations by eliminating constraints associated with traditional steering columns, brake pedals, and boost systems for left-hand and right-hand drive variations. These systems can be implemented across multiple platforms with fewer packaging limitations. High levels of autonomy represent a feature that can benefit from power conversion redundancy, and the reduction in power conversion redundancy can contribute to lowering the cost of architectures that support these functionalities.

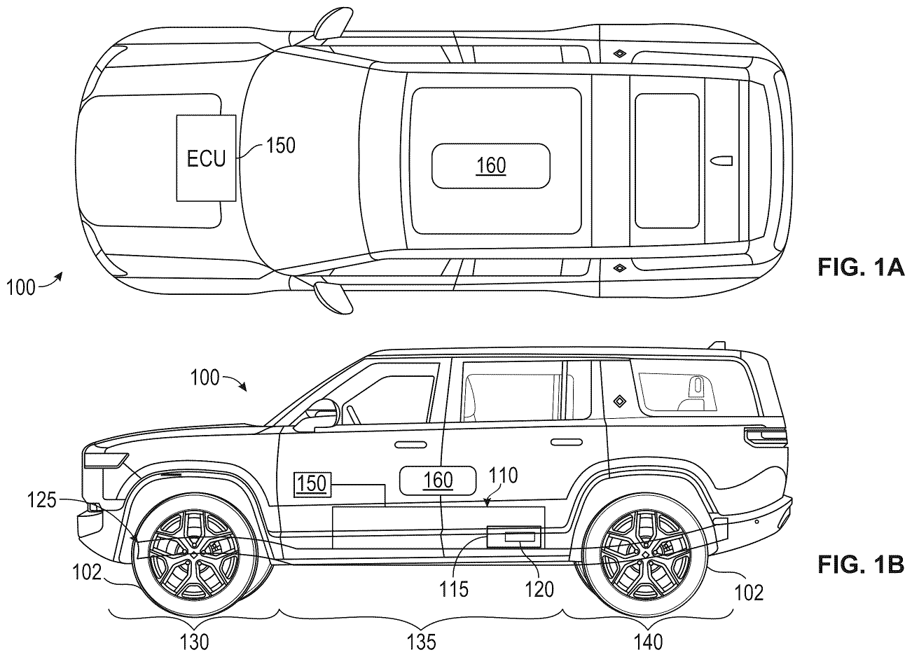

FIG. 1A illustrates an example overhead view of vehicle 100. As further described herein, vehicle 100 may include one or more ECUs in front portion 130 of vehicle 100 (e.g., ECU 150), among other things. An ECU (e.g., ECU 150) is an embedded system that may control one or more of the electrical systems or subsystems in the vehicle 100.

FIG. 1B illustrates an example side view of vehicle 100. As shown, the vehicle 100 may include one or more battery packs, such as high voltage (HV) battery pack 110 (e.g., 450V), which may be located near the center body portion 135 of vehicle 100. HV battery pack 110 may be coupled with one or more electrical systems of the vehicle 100 to provide power to the electrical systems. In one or more implementations, ECU 150 may be communicatively connected with or have power distributed with each other and may be functionally redundant for power or other operations of electronic components of vehicle 100.

In one or more implementations, the vehicle 100 may be an electric vehicle having one or more electric motors that drive wheels 102 of the vehicle 100 using electric power from HV battery pack 110. In one or more implementations, vehicle 100 may also, or alternatively, include one or more chemically powered engines, such as a gas-powered engine or a fuel cell powered motor. For example, electric vehicles can be fully electric or partially electric (e.g., hybrid or plug-in hybrid). In various implementations, vehicle 100 may be a fully autonomous vehicle that can navigate roadways without a human operator or driver, a partially autonomous vehicle that can navigate some roadways without a human operator or driver or that can navigate roadways with the supervision of a human operator, may be an unmanned vehicle that can navigate roadways or other pathways without any human occupants, or may be a human operated (non-autonomous) vehicle configured for a human operator.

In the example of FIG. 1B, the vehicle 100 may be implemented as a truck (e.g., a pickup truck) having a battery pack 110. As shown, HV battery pack 110 may include one or more battery modules 115, which may include one or more battery cells 120. However, this is merely illustrative and, in other implementations, HV battery pack 110 may be provided without any battery modules 115 (e.g., in a cell-to-pack configuration).

As shown in FIG. 1B, vehicle 100 may include a support structure such as a chassis 125 (e.g., a frame, internal frame, or other support structure). The chassis 125 may support various components of the vehicle 100. As shown, the chassis 125 may span a front portion 130 (e.g., a hood or bonnet portion), center body portion 135, and a rear portion 140 (e.g., a trunk, payload, or boot portion) of the vehicle 100 in some implementations. In one or more implementations, HV battery pack 110 may be installed on the chassis 125 (e.g., within one or more of the front portions 130, center body portion 135, or the rear portion 140). In one or more other implementations, HV battery pack 110 may include or be electrically coupled with one or more one busbars (e.g., one or more current collector elements), of which may include electrically conductive material to connect or otherwise electrically couple battery module(s) 115 or the battery cell(s) 120 with other electrical components of vehicle 100 to provide electrical power to various systems or components of vehicle 100.

In one or more other implementations, the vehicle 100 may be implemented as another type of electric truck, an electric delivery van, an electric automobile, an electric car, an electric motorcycle, an electric scooter, an electric passenger vehicle, an electric passenger or commercial truck, a hybrid vehicle, or other vehicles such as sea or air transport vehicles, planes, helicopters, submarines, boats, or drones, or any other movable apparatus having a battery pack 110 (e.g., that powers the propulsion or drive components of the moveable apparatus).

In one or more implementations, the vehicle 100 includes a power management system 160 that includes DC-DC converters that are used to step down energy from a high-voltage battery pack (e.g., the HV battery pack 110) to supply energy to low-voltage subsystems distributed throughout the vehicle 100. Among these low-voltage subsystems are components categorized as “safety critical systems.” For applications where availability of such systems is beneficial to safety, power is provisioned through two independent sources to mitigate the impact of single-point failures. For example, in the event of a headlight failure, a fault notification alone may not be sufficient, as the system may still need to address the operational impact—particularly in scenarios such as nighttime driving. In one or more implementations, the electrical architecture is configured to prevent simultaneous failure of both headlights due to a common fault. This approach can become increasingly applicable in higher levels of vehicle autonomy, where driver disengagement from active vehicle control is expected. In one or more implementations, fault conditions may not be managed solely through driver takeover prompts. In one or more other implementations, the system can be configured to support execution of a “minimum risk maneuver,” which maintains safety-critical operations for a limited duration. This duration may be intended to either allow re-engagement of the driver or enable the vehicle 100 to achieve a controlled stop.

The power management system 160 may employ one DC-DC converter as one power source and a low voltage (LV) battery (e.g., 12V) as a secondary source, with the two sources interconnected through an isolation switch to enable redundancy and fault tolerance. Technical challenges may be associated with the deployment of LV batteries in vehicular systems. In one or more implementations, LV batteries present challenges related to the estimation of internal states, including electrochemical dynamics and thermal characteristics under various loading conditions. In one or more other implementations, the power management system 160 may remove the LV battery as a dedicated energy source and include an architecture incorporating two DC-DC converters. This configuration can facilitate improved control of power availability across low-voltage subsystems with equivalent redundancy and fault-handling mechanisms. By having an architecture incorporating the dual DC-DC converter configurations, the power management system 160 also may incorporate a split-pack topology and two LV DC-DC converters (e.g., 12V DC-DC converters).

Further architectural evolution is driven by the transition toward “brake-by-wire” and “steer-by-wire” systems, which can eliminate mechanical linkages between the user input mechanisms—such as the steering wheel or brake pedal—and the actuated components of the vehicle's motion control system. These systems may operate entirely through electronic control and signal transmission. In one or more implementations, redundancy provisioning becomes beneficial, as uninterrupted functionality is beneficial to safety in the presence of faults. Given the high current demands of these subsystems, the power management system 160 may employ a 48V system that provides a beneficial reduction in conductor cross-sectional area due to the quadratic inverse relationship between current and wire gauge for a given power level. This can result in reductions in wiring harness mass and bill-of-materials cost.

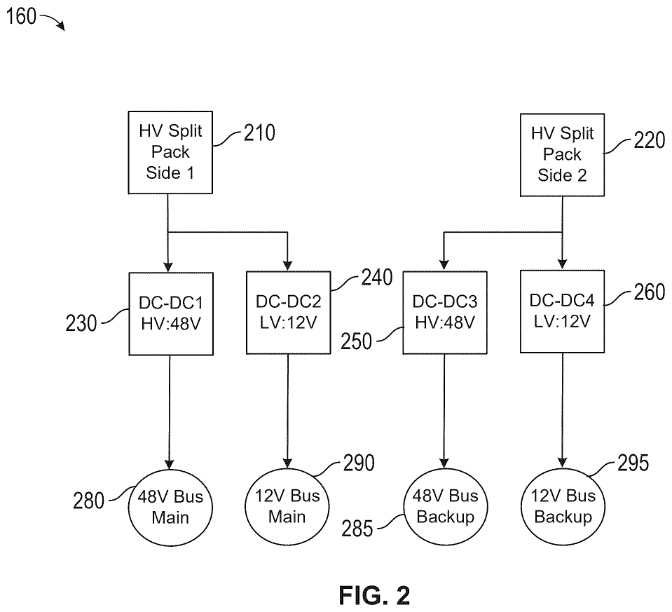

FIG. 2 illustrates an exemplary block diagram of a power management system (e.g., the power management system 160) that includes multiple power converters in accordance with one or more implementations. In one or more implementations, the power management system 160 can support safety-critical features without reliance on a 12V battery by employing a configuration in which separate DC-DC converters are allocated per voltage domain and per physical battery pack segment. For example, the power management system 160 includes a first high-voltage (HV) split-pack 210 and a second high-voltage (HV) split-pack 220. The first HV split-pack 210 is configured to supply power to a first power converter 230 and a second power converter 240. The first power converter 230 is configured to convert the received high-voltage power to a 48V output and deliver power to a main 48V bus 280. The second power converter 240 is configured to convert the received high-voltage power to a 12V output and deliver power to a main 12V bus 290. The second HV split-pack 220 is configured to supply power to a third power converter 250 and a fourth power converter 260. The third power converter 250 is configured to convert the received high-voltage power to a 48V output and deliver power to a backup 48V bus 285. The fourth power converter 260 is configured to convert the received high-voltage power to a 12V output and deliver power to a backup 12V bus 295.

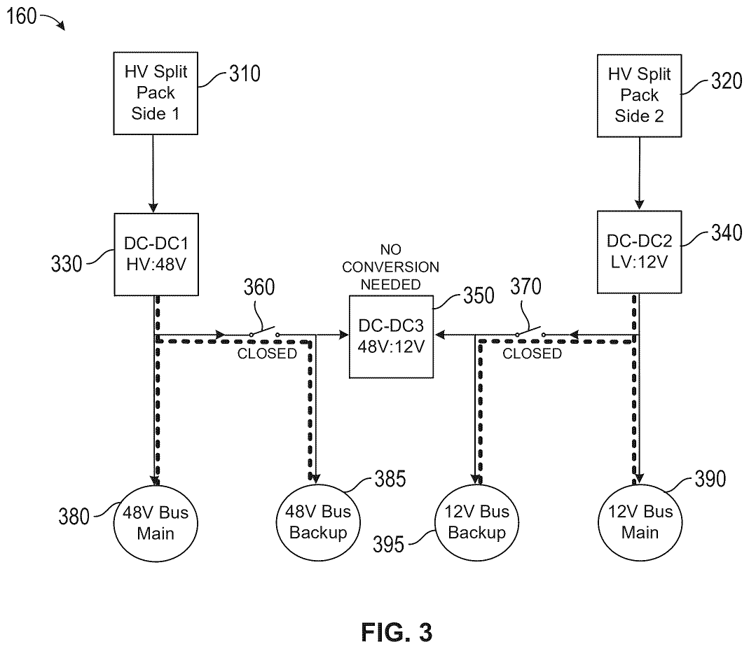

In one or more implementations, the number of DC-DC converters in the power conversion stage can be reduced to three instead of four, without reliance on alternative power sources, while maintaining the safety of availability beneficial for BBW, SBW, and SD systems. For example, the power management system 160 can consolidate the functionality of the two backup DC-DC converters (e.g., third power converter 250 and fourth power converter 260) into a single bidirectional power converter configured to convert between 48 volts and 12 volts in both directions, as will be discussed in more detail with reference to FIG. 3. This configuration can yield equivalent functionality to the dual-converter architecture by maintaining primary and backup power delivery capability for both 48V and 12V networks. In one or more other implementations, the architecture can include a monitoring and control mechanism capable of fault detection and reconfiguration. Upon detection of a power delivery fault, the system can redirect energy flow across domains to maintain operational redundancy across both voltage levels. In one or more other implementations, such monitoring and control mechanism may be implemented by way of at least in part on the ECU 150.

FIG. 3 illustrates an exemplary block diagram of a power management system (e.g., the power management system 160) that includes multiple power converters with enhanced redundancy in accordance with one or more implementations. The power management system 160 is configured with multiple power converters to manage power distribution between different voltage domains. As illustrated in FIG. 3, the power management system 160 includes a first HV split-pack 310 that supplies power to a first power converter 330. In one or more implementations, the first power converter 330 is configured as a 48V converter, which can reduce the high-voltage input down to 48V. The 48V output from first power converter 330 can be supplied to a main 48V bus 380 and a backup 48V bus 385, with power distribution to the backup 48V bus 385 being controlled by an isolation switch 360. When the isolation switch 360 is closed, power is supplied to the backup 48V bus 385.

The power management system 160 also includes a second HV split-pack 320 that supplies power to a second power converter 340. In one or more implementations, the second power converter 340 is configured as a 12V converter, which can reduce the high-voltage input down to 12V. The 12V output from second power converter 340 can be supplied to a main 12V bus 390 and a backup 12V bus 395, with power distribution to the backup 12V bus 395 being controlled by an isolation switch 370. When the isolation switch 370 is closed, power is supplied to the backup 12V bus 395.

The power management system 160 also includes a third power converter 350 positioned between the 48V and 12V domains. In one or more implementations, the third power converter 350 is configured to convert power between these domains in a directional manner. If the isolation switch 370 is open, the third power converter 350 can convert 48V to 12V and supply power to the backup 12V bus 395. Conversely, if the isolation switch 360 is open, the third power converter 350 can convert 12V to 48V and supply power to the backup 48V bus 385. This configuration facilitates flexible power routing, allowing continuous power supply to the backup buses as needed. As illustrated in FIG. 3, no fault conditions are present in the power management system 160, so no conversion by the third power converter 350 may be needed to supply power between the voltage domains as each voltage domain can supply power to its main and backup power paths.

In one or more other implementations, when a fault condition is detected in the power management system 160, the power management system 160 may reconfigure the power paths between the voltage domains to maintain power availability to at least one of the 12V networks and one of the 48V networks, facilitating continuous operation across low-voltage subsystems with equivalent redundancy and fault-handling mechanisms.

In one or more other implementations, monitoring functionality can be directly integrated within the third power converter 350. In such implementation, the third power converter 350 can monitor the operational status of either the first isolation switch 360 or the second isolation switch 370, and potentially the output conditions of other power converters within the power management system 160. In this regard, the third power converter 350 may determine the appropriate response action, including whether to initiate or adjust its power conversion function.

In one or more implementations, the isolation switches (e.g., isolation switches 360, 370) can represent a beneficial functional component within the power management system 160, as they determine the configuration of energy transfer paths in response to system events. The behavior of these isolation switches can be influenced by specific triggers or detected conditions that indicate fault scenarios within the power management system 160. In one or more other implementations, each isolation switch can be electrically connected to network monitoring circuitry capable of autonomous operation.

In one or more implementations, isolation switches (e.g., isolation switches 360, 370) may be configured with a default closed state. This configuration can allow power to flow simultaneously to both the main and backup busses of the respective voltage domain under nominal operating conditions. The closed state also facilitates monitoring by at least one node connected to that isolation switch, allowing detection of electrical conditions such as current surges or voltage deviations.

These isolation switches (e.g., isolation switches 360, 370) can transition to an open state under specific conditions, primarily in response to detected faults that can affect system stability or redundancy. In one or more implementations, the isolation switches can be interfaced with one or more microcontrollers capable of issuing control commands. While microcontroller-based actuation can introduce slower response times compared to autonomous switching, it can enable conditional override logic. For example, if the microcontroller detects that one side of the isolation switch has already been disconnected (e.g., fault detected on side with isolation switch 360), the microcontroller may issue a command to keep the opposing isolation switch (e.g., isolation switch 370) in the closed state to maintain power delivery to the backup bus of the opposing voltage domain. This can prevent unnecessary disconnection that would otherwise result in power loss to specific low-voltage subsystems. In one or more implementations, the one or more microcontrollers may be included in the ECU 150. In one or more other implementations, the one or more microcontrollers may be separate from the ECU 150 and may be communicatively coupled to the ECU 150.

The isolation switches (e.g., isolation switches 360, 370) can provide independent, high-speed response with actuation times on the order of approximately 500 microseconds, for example. These isolation switches can respectively include fault detection circuits to continuously monitor current and voltage levels on both sides of the electrical domain they separate. Upon detection of electrical parameters deviating from predefined specifications—such as excessive current draw or voltage droop—the isolation switch can initiate an open-state transition to interrupt current flow. This action is intended to localize the fault and prevent its propagation to the adjacent power network. For example, in a condition where an unregulated line experiences a short-to-ground fault, current can be diverted from a primary bus through the faulted line. This can result in excessive current draw and voltage sag across both affected buses, potentially leading to a loss of functionality on both voltage domains. The isolation switch can identify the resulting current surge or voltage anomaly and actuate to open the connection, preserving the operational integrity of the unaffected, or “healthy,” side of the power management system 160.

In addition to isolation switches, the power management system 160 may include protective switches, such as smart fuses or electronic fuses, placed between a power converter output and each load. For example, critical automotive systems like steering or braking can each be connected through additional switches that provide local protection. If a fault such as a short circuit occurs in any of these subsystems, the corresponding protective switch can transition to an open state, facilitating that power is preserved for other subsystems and minimizing the impact of the fault. These protective switches can work in conjunction with the isolation switches to facilitate that faults are isolated locally, preventing them from propagating and affecting the entire power management system 160.

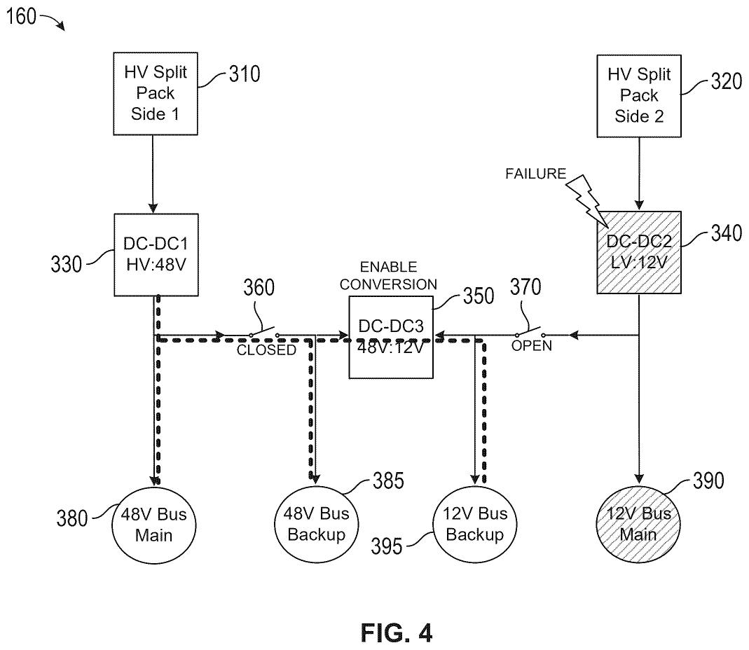

FIG. 4 conceptually illustrates an example of a first fault condition in the power management system 160 of FIG. 3 that includes multiple power converters with enhanced redundancy in accordance with one or more implementations. As illustrated in FIG. 4, the second power converter 340 experiences a failure such that an absence of corrective action can result in a complete loss of power to all 12V subsystems (e.g., main 12V bus 390 and backup 12V bus 395). To mitigate this, the power management system 160 can initiate a response in which the isolation switch 370 transitions to an open state. This action can enable the third power converter 350 to perform a voltage step-down operation from the 48V domain to the 12V domain.

In this configuration, the 12V subsystems may no longer be powered by the second power converter 340 but instead receive power routed from the 48V domain through the third power converter 350. This reconfiguration can result in a loss of the primary 12V bus 390, but the backup 12V bus 395 becomes active, maintaining availability of 12V power to subsystems in the 12V domain. In one or more implementations, when power delivery to the 12V domain becomes dependent on the third power converter 350 due to a failure in the second power converter 340, the power management system 160 may transition to a backup conversion pathway. In this configuration, the third power converter 350 is enabled to perform voltage conversion from the 48V domain to the 12V domain, as denoted by the bold dashed line running across the third power converter 350 to the backup 12V bus 395.

Prior to the fault condition, the isolation switch 370 may initially be in a closed state. By having the isolation switch 370 in a closed state, continuous monitoring of electrical conditions can be monitored across the connected power domains. In one or more implementations, the isolation switch 370 may include threshold-based detection mechanisms that evaluate real-time parameters such as voltage and current. Upon detection of a fault condition—such as a rapid voltage drop on one side of the isolation switch 370 or a reversal in current direction that exceeds expected tolerances—the isolation switch 370 may initiate a response by transitioning to an open state. This response by transitioning from the closed state to the open state can help isolate the faulted domain to prevent propagation of the failure to other sections of the voltage domain and/or to the other voltage domain. In one or more implementations, the isolation switch 370 can function as a bidirectional device, monitoring current flow in both directions and reacting when the current exceeds predefined operational limits. In one or more other implementations, voltage levels on both sides of the bus also can be monitored to support accurate and timely fault detection.

Upon detection that the isolation switch 370, connected to the second power converter 340, has transitioned to an open state—indicating a fault—the microcontroller may issue a command to the third power converter 350 to initiate power conversion. In one or more other implementations, the microcontroller may maintain the closed state of the isolation switch 360 to ensure uninterrupted power delivery between the voltage domains.

In one or more implementations, the voltage set point of the third power converter 350 can be configured to be slightly lower than that of the second power converter 340. Under normal conditions, this can cause power to be drawn preferentially from the second power converter 340. In the event of a fault condition associated with the second power converter 340 as illustrated in FIG. 3, the power management system 160 can passively transition to draw power from the third power converter 350 due to the loss of the higher-voltage source (e.g., the second power converter 340 with the higher voltage set point). In one or more other implementations, this form of load-sharing transition can be implemented via hardware logic independent of any active microcontroller intervention.

In one or more other implementations, the third power converter 350 and the second power converter 340 may participate in active load balancing by having the third power converter 350 operate in parallel with the second power converter 340 during normal system conditions. Under this configuration, the third power converter 350 may continuously perform power conversion at a reduced or partial output level. If the second power converter 340 fails, the power management system 160 may not activate the third power converter 350 from an idle state but rather increases its output level to compensate for the power deficit.

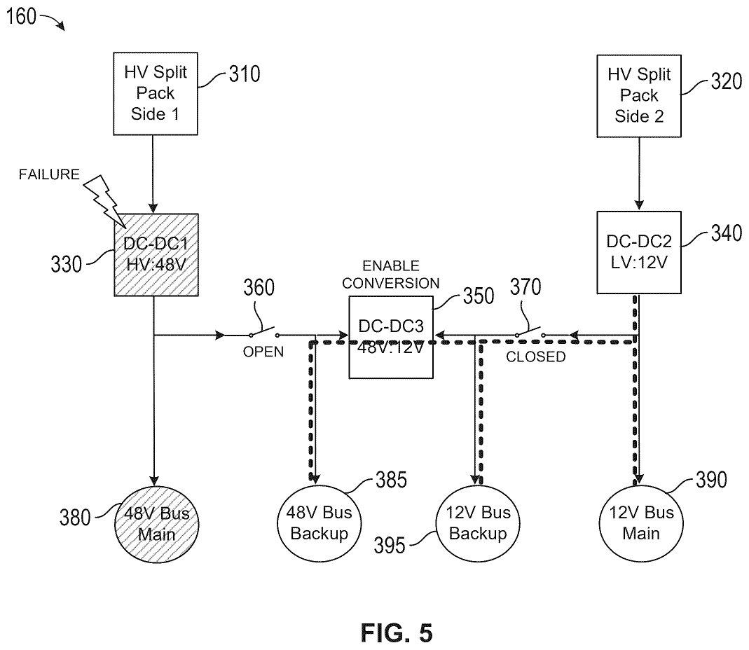

FIG. 5 conceptually illustrates an example of a second fault condition in the power management system 160 of FIG. 3 that includes multiple power converters with enhanced redundancy in accordance with one or more implementations. As illustrated in FIG. 5, the first power converter 330 experiences a failure and becomes non-operational such that an absence of corrective action can result in a complete loss of power to all 48V subsystems (e.g., main 48V bus 380 and backup 48V bus 385). To mitigate this, the power management system 160 can initiate a response in which the isolation switch 360 transitions to an open state to isolate the faulted domain (e.g., 48V domain). This action can enable the third power converter 350, which is bidirectional, to perform a voltage step-up operation from the 12V domain to the 48V domain. This operation enables the third power converter 350 to supply power to the backup 48V bus 385 via the isolation switch 370 in a closed state.

Control of this transition may be initiated either passively through a voltage set-point prioritization—where the third power converter 350 has a lower voltage reference than the first power converter 330 under normal operation—or actively through a hardware or software monitoring subsystem that detects the fault and commands the appropriate isolation switch state changes. This response can facilitate continued power availability to 48V subsystems by rerouting power through the third power converter 350 and maintaining the integrity of the backup power path (e.g., the backup 48V bus 385) in the 48V domain.

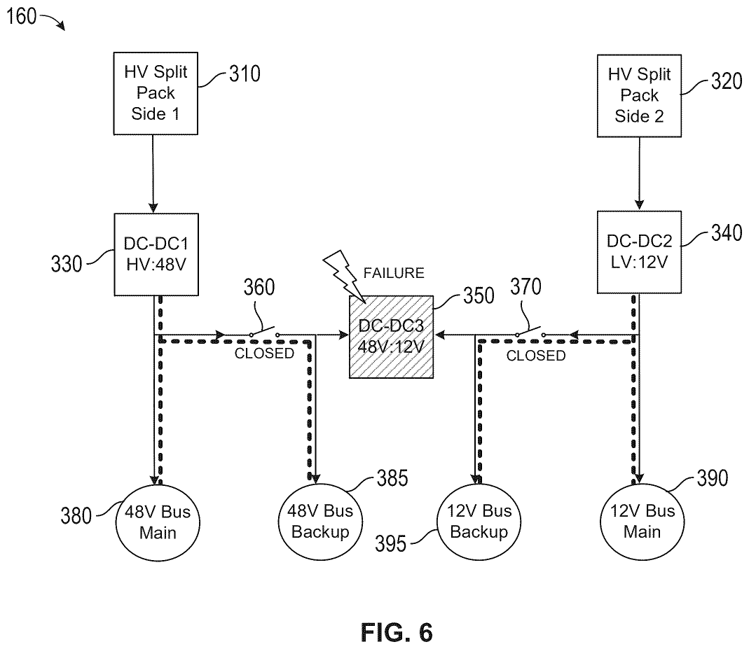

FIG. 6 conceptually illustrates an example of a third fault condition in the power management system 160 of FIG. 3 that includes multiple power converters with enhanced redundancy in accordance with one or more implementations. As illustrated in FIG. 6, the third power converter 350. Upon occurrence of the fault condition, the third power converter 350 ceases its conversion function, which may not significantly affect the operation of the main power busses and backup power paths. For example, each voltage domain can still supply power to its main (e.g., main 48V bus 380, main 12V bus 390) and backup power paths (e.g., backup 48V bus 385, backup 12V bus 395). Although the third power converter 350 may be rendered inoperative, the main busses and backup busses continue to operate normally without disruption, facilitating that subsystems powered by the main busses and redundancy in the backup power paths.

If the third power converter 350 stops outputting power, the isolation switches 360, 370 may not need to react unless there is a short circuit or an under-voltage condition. In the absence of these conditions, the power management system 160 can continue to operate without triggering any one of the isolation switches 360, 370. It is beneficial for the power management system 160 to maintain enough power availability to bring the vehicle 100 and its occupants to a safe stop. In one or more other implementations, the power management system 160 may not be configured for prolonged operation but to handle a critical system failure and facilitate the safe stoppage of vehicle movement.

In one or more other implementations, both backup power paths may be shorted internally, potentially leading to a fault condition that causes both backup busses to ground. The short circuit observed in the backup power paths may trigger the respective isolation switches (e.g., 360, 370) to open, effectively isolating the faulted busses to prevent further propagation of the fault condition to either of the main busses. Despite this fault condition, the power management system 160 can remain operational, as the failure may not affect the main power busses. For example, at least one 48V and one 12V power path can remain functional, allowing continued power availability to specific low-voltage subsystems to maintain redundancy and system stability even in the event of an internal short or fault affecting the backup power paths.

In one or more other implementations, a fault condition may be detected in which an unregulated conversion process occurs, possibly due to a corrupted set-point, causing the power management system 160 to attempt to draw excessive power from one voltage domain and push it into the opposite voltage domain. In this case, the third power converter 350 may fail to regulate properly, drawing too much power into the wrong direction. This can lead to the activation of the isolation switches 360, 370, which transition to an open state to prevent further damage. As a result, the two affected backup power paths can be isolated, while at least one 48V and one 12V power path can continue to operate, facilitating that power availability is maintained.

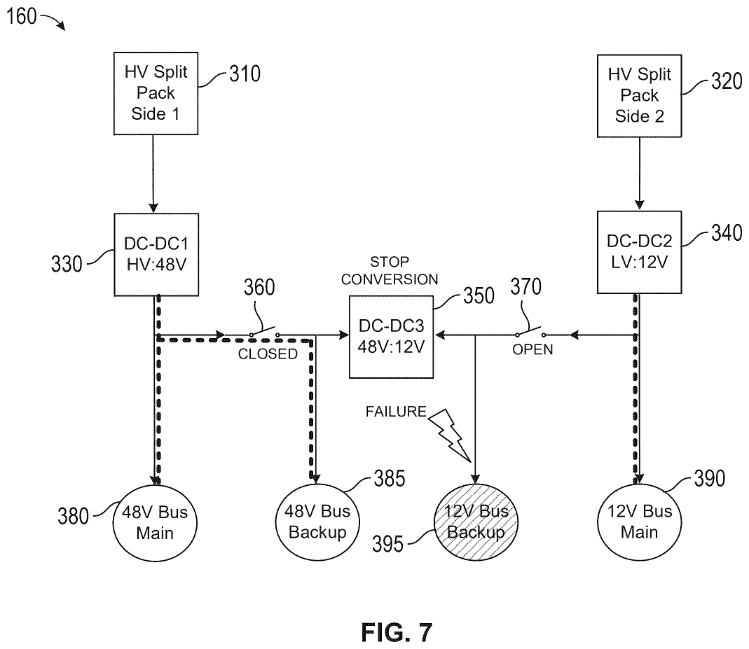

FIG. 7 conceptually illustrates an example of a fourth fault condition in the power management system 160 of FIG. 3 that includes multiple power converters with enhanced redundancy in accordance with one or more implementations. As illustrated in FIG. 7, the power path to the backup 12V bus 395 experiences a failure, in which a short occurs on the internal line between the third power converter 350 and the backup 12V bus 395. In this case, the response involves stopping the conversion process of the third power converter 350, and isolation switch 370 transitioning to an open state to prevent further damage. For example, the first power converter 330 can supply power to both the main 48V bus 380 and backup 48V bus 385, while the second power converter 340 supplies power to the main 12V bus 390. The backup 12V bus 395 remains isolated from the 12V domain by way of the isolation switch 370 remaining in the open state and isolated from the 48V domain by way of the third power converter 350 ceasing its conversion operation.

This reconfiguration can facilitate that the voltage domain protected by third power converter 350 is safeguarded by halting its conversion process, while the voltage domain protected by the isolation switch 370 is isolated from the fault. In the event that the third power converter 350 continues to convert erroneously, the isolation switch 370 can transition to the open state again, providing an additional layer of protection. This dual protection approach increases the reliability of the power management system 160, isolating faults from critical low-voltage subsystems and maintaining overall system integrity.

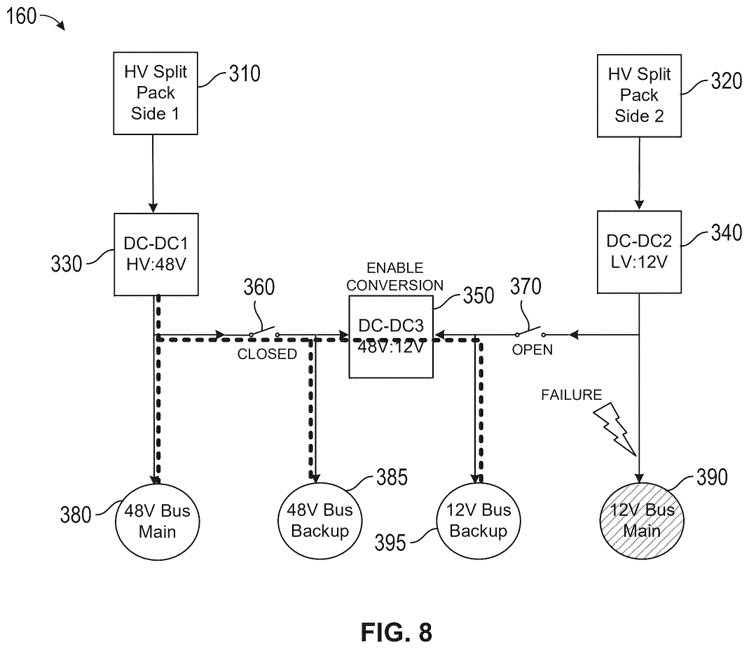

FIG. 8 conceptually illustrates an example of a fifth fault condition in the power management system 160 of FIG. 3 that includes multiple power converters with enhanced redundancy in accordance with one or more implementations. As illustrated in FIG. 8, the power path to the main 12V bus 390 experiences a failure, in which a short occurs on the external line between the second power converter 340 and the main 12V bus 390. If the fault occurs on the external load side, the isolation switch 370 transitions to the open state, protecting the backup 12V bus 395 from the fault. In one or more implementations, the third power converter 350 may detect the fault and/or receive a command indicating the fault, thus initiating power conversion from the 48V domain to supply the backup 12V bus 395. As illustrated in FIG. 8, the isolation switch 370 remains open during the fault condition to protect the backup 12V bus 395 and 48V domain from the fault while the isolation switch 360 remain in the closed state to facilitate the power conversion from the 48V domain to the 12V domain through the third power converter 350. This configuration facilitates that the backup power system remains operational by redirecting power from the higher voltage domain (e.g., 48V) to the backup 12V bus 395 as needed.

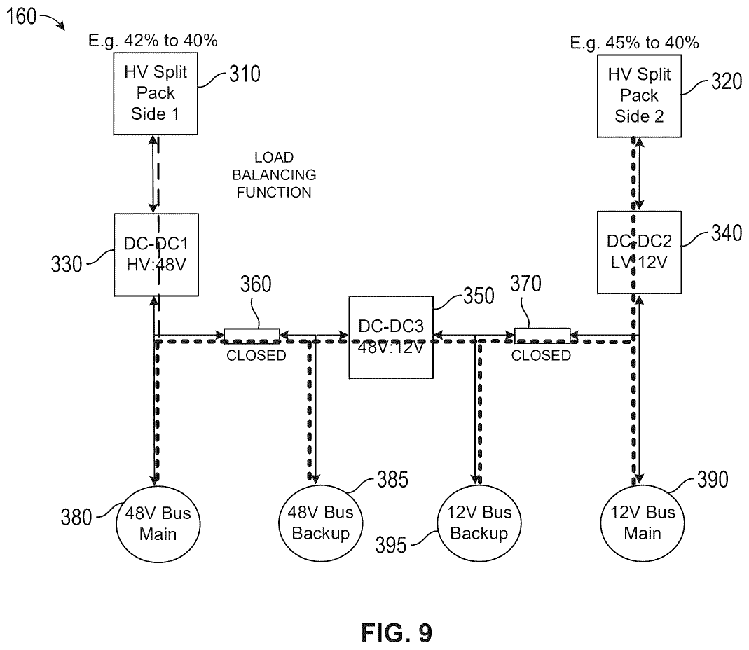

FIG. 9 conceptually illustrates an example of a load balancing function in the power management system 160 of FIG. 3 that includes multiple power converters with enhanced redundancy in accordance with one or more implementations. In addition to providing power to the loads, the power management system 160 can perform load balancing, which allows for compensation between the two voltage domains. As illustrated in FIG. 9, the first power converter 330 may operate in a deficit, meaning that the power supplied by the first power converter 330 is lower than the total power drawn by the 48V busses (e.g., main 48V bus 380 and backup 48V bus 385). To offset this deficit, the second power converter 340 provides 12V power at a level that exceeds the power consumption of the 12V busses (e.g., main 12V bus 390 and backup 12V bus 395).

The power management system 160 may initiate an energy transfer such that the load balancing function involves bidirectional energy flow. For example, the surplus energy generated by the second power converter 340, not consumed by the 12V busses, is routed through the third power converter 350 while the second isolation switch 370 remains in the closed state, to perform a 12V to 48V conversion. The converted power is routed from the third power converter 350 to the first power converter 330 while the first isolation switch 360 remains in the closed state. This converted power can supplement the power deficit at the first power converter 330. The result of this operational state is a net increase in power drawn from the second HV split-pack 320 than the first HV split-pack 310, which causes the second HV split-pack 320 to discharge at a faster rate than the first HV split-pack 310. The load balancing process may continue until the state of charge (SOC) of the first HV split-pack 310 and the second HV split-pack 320 equalizes at a lower SOC level (e.g., at around 42%). At this equilibrium point, the first power converter 330, the second power converter 340, and the third power converter 350 can revert to balanced operating conditions in which neither excess nor deficit conditions are present.

In one or more implementations, the load balancing process can be categorized into three stages. The first stage may refer to passive balancing, where resistors are used to slowly balance the charge between the two sides internally within the battery pack 110 (or separately across the first HV split-pack 310 and second HV split-pack 320). The second stage may refer to load balancing, where more power is drawn deliberately from one side to equalize the energy. The final stage may refer to active balancing, where energy is transferred from one side to the other to achieve an equal state between the two sides.

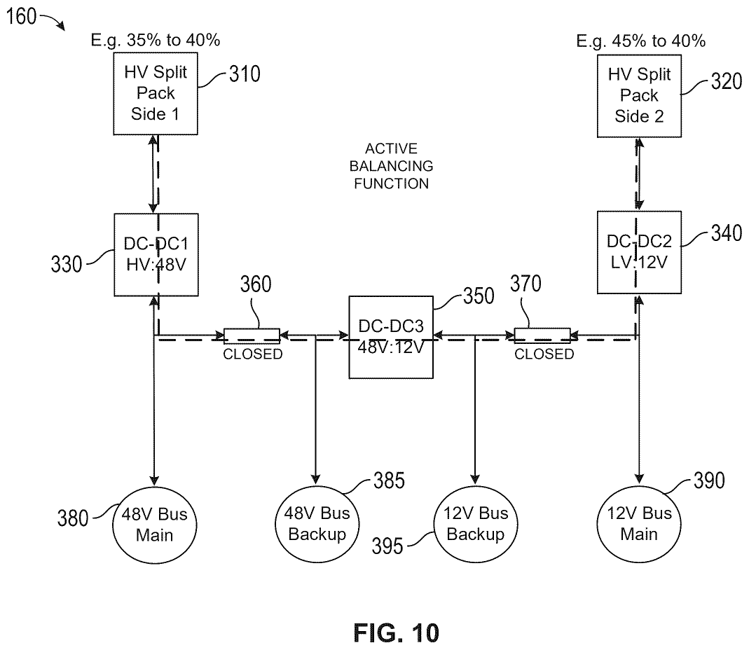

FIG. 10 conceptually illustrates an example of an active balancing function in the power management system 160 of FIG. 3 that includes multiple power converters with enhanced redundancy in accordance with one or more implementations. Active balancing between the two battery packs (e.g., first HV split-pack 310 and second HV split-pack 320) may involve transferring energy through a conversion chain to equalize the energy stored in each pack. The power management system 160 may initiate an energy transfer such that the active balancing function involves bidirectional energy flow. In the case where one pack is used more frequently than the other—such as a 70% usage rate for one and 30% for the other—this imbalance can cause the more frequently used pack to deplete faster, leading to an earlier depletion of usable energy. In one or more implementations, through the balancing mechanism, when one pack reaches a lower state of charge, such as 35%, while the other is at 45%, energy can be converted and transferred between the packs. This process helps balance the state of charge, bringing both packs closer to equal levels, such as 40% for each. The active balancing process may be performed gradually, resulting in small adjustments in charge, optimizing energy usage and extending the operational life of the two battery packs.

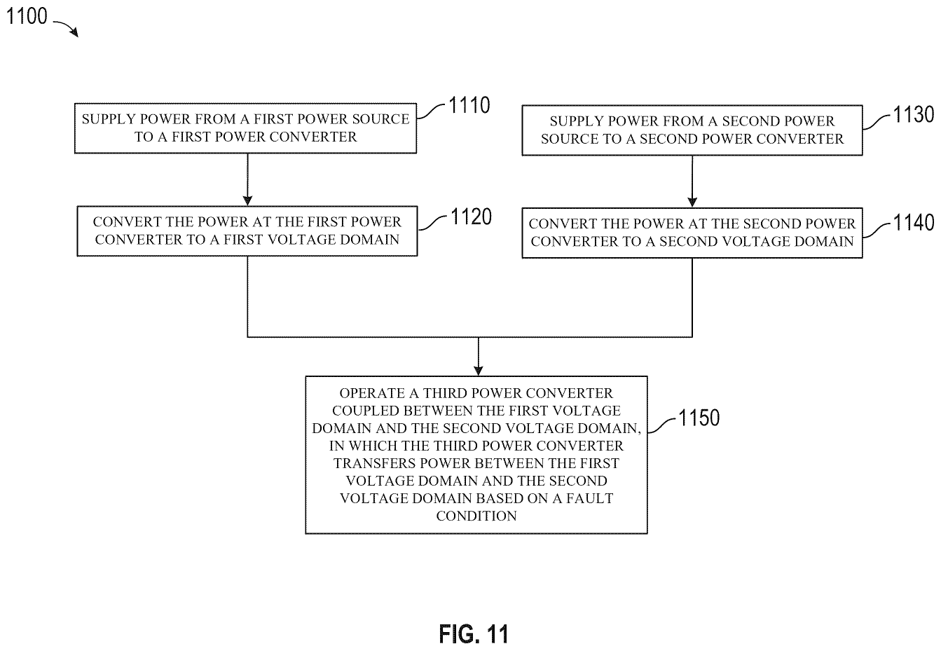

FIG. 11 is a flow diagram of illustrative operations of a process 1100 that may be performed for enhanced over-the-air programming of power management integrated circuits in accordance with one or more implementations. The flow diagram may be implemented by a power management system shown and/or described herein. For explanatory purposes, the process 1100 is primarily described herein with reference to the vehicle 100 of FIGS. 1A and 1B, the power management system 160 of FIGS. 1A, 1B, and 3-10, the first HV split-pack 310 of FIGS. 3-10, the second HV split-pack 320 of FIGS. 3-10, first power converter 330 of FIGS. 3-10, second power converter 340 of FIGS. 3-10, third power converter 350 of FIGS. 3-10, and/or various components thereof. However, the process 1100 is not limited to the vehicle 100 of FIGS. 1A and 1B, the power management system 160 of FIGS. 1A, 1B, and 3-10, the first HV split-pack 310 of FIGS. 3-10, the second HV split-pack 320 of FIGS. 3-10, first power converter 330 of FIGS. 3-10, second power converter 340 of FIGS. 3-10, third power converter 350 of FIGS. 3-10, and one or more blocks (or operations) of the process 1100 may be performed by one or more other structural components of the vehicle 100 and/or of other suitable moveable apparatuses, devices, or systems. Further, for explanatory purposes, some of the blocks of the process 1100 are described herein as occurring in serial, or linearly. However, multiple blocks of the process 1100 may occur in parallel. In addition, the blocks of the process 1100 need not be performed in the order shown and/or one or more blocks of the process 1100 need not be performed and/or can be replaced by other operations.

At block 1110, the power management system 160 may supply power from a first power source (e.g., the first HV split-pack 310) to a first power converter (e.g., the first power converter 330).

At block 1120, the power management system 160 may convert the power at the first power converter 330 to a first voltage domain (e.g., 48V). In one or more implementations, power may be supplied from the first power converter 330 to a primary load in the first voltage domain (e.g., main 48V bus 380) and to a redundant load in the first voltage domain (e.g., backup 48V bus 385) through a first isolation switch (e.g., the first isolation switch 360). For example, power is supplied to the backup 48V bus 385 when the first isolation switch 360 is closed.

At block 1130, the power management system 160 may supply power from a second power source (e.g., the second HV split-pack 320) to a second power converter (e.g., the second power converter 340).

At block 1140, the power management system 160 may convert the power at the second power converter 340 to a second voltage domain (e.g., 12V). In one or more implementations, power may be supplied from the second power converter 340 to a primary load in the second voltage domain (e.g., main 12V bus 390) and to a redundant load in the second voltage domain (e.g., backup 12V bus 395) through a second isolation switch (e.g., the second isolation switch 370). For example, power is supplied to the backup 12V bus 395 when the second isolation switch 370 is closed.

At block 1150, the power management system 160 may operate a third power converter (e.g., the third power converter 350) coupled between the first voltage domain (e.g., 48V) and the second voltage domain (e.g., 12V). In this regard, the power management system 160 can provide bidirectional power transfer between the first voltage domain (e.g., 48V) and the second voltage domain (e.g., 12V) via the third power converter 350. In some aspects, the third power converter 350 can transfer power between the first voltage domain and the second voltage domain based on a fault condition. In one or more implementations, the first isolation switch 360 may be transitioned to an open state upon detecting a fault associated with the first voltage domain (e.g., 48V). As such, the redundant load in the first voltage domain (e.g., backup 48V bus 385) may be disconnected from the first power converter 330. In one or more implementations, when the first isolation switch 360 is open, power may be converted from the second voltage domain (e.g., 12V) to the first voltage domain (e.g., 48V) through the third power converter 350. The third power converter 350 may supply the converted power to the redundant load in the first voltage domain (e.g., backup 48V bus 385) when the first isolation switch 360 is open. In one or more other implementations, when the second isolation switch 370 is open, power may be converted from the first voltage domain (e.g., 48V) to the second voltage domain (e.g., 12V) through the third power converter 350. The third power converter 350 may supply the converted power to the redundant load in the second voltage domain (e.g., backup 12V bus 395) when the second isolation switch 370 is open.

The methods described herein, combining direct sensing, integrated temperature monitoring, and strategic packaging, represents an approach to low voltage battery management in electric vehicles. The methods, systems, or apparatuses disclosed herein may be incorporated into electric vehicles or other devices. The circuit blocks disclosed herein may be distributed with or combined with one or more ECUs or other devices. The methods, systems, or apparatuses disclosed herein may be incorporated into products, such as various feature specific or zone-specific electronic control units (ECUs).

The term “or” is used inclusively unless otherwise disclosed. As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

When an element is referred to herein as being “connected” or “coupled” to another element, it is to be understood that the elements can be directly connected to the other element, or have intervening elements present between the elements. In contrast, when an element is referred to as being “directly connected” or “directly coupled” to another element, it should be understood that no intervening elements are present in the “direct” connection between the elements. However, the existence of a direct connection does not exclude other connections, in which intervening elements may be present.

The predicate words “configured to”, “operable to”, and “programmed to” do not imply any particular tangible or intangible modification of a subject, but, rather, are intended to be used interchangeably. In one or more implementations, a processor configured to monitor and control an operation or a component may also mean the processor being programmed to monitor and control the operation or the processor being operable to monitor and control the operation. Likewise, a processor configured to execute code can be construed as a processor programmed to execute code or operable to execute code.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

The word “exemplary” is used herein to mean “serving as an example, instance, or illustration”. Any embodiment described herein as “exemplary” or as an “example” is not necessarily to be construed as preferred or advantageous over other embodiments. Furthermore, to the extent that the term “include”, “have”, or the like is used in the description or the claims, such term is intended to be inclusive in a manner similar to the term “comprise” as “comprise” is interpreted when employed as a transitional word in a claim.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for”.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more”. Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

What is claimed is:

1. A system comprising:
a first power converter configured to receive power from a first power source and convert the received power to a first voltage domain, wherein power from the first power converter is provided to a first power path comprising a primary load in the first voltage domain and a redundant load in the first voltage domain;
a second power converter configured to receive power from a second power source and convert the received power to a second voltage domain different from the first voltage domain, wherein power from the second power converter is provided to a second power path comprising a primary load in the second voltage domain and a redundant load in the second voltage domain; and
a third power converter coupled between the first voltage domain and the second voltage domain, wherein the third power converter is configured to transfer power between the first power path and the second power path based on a fault condition.

2. The system of claim 1, further comprising:
a first isolation switch coupled to the first power converter and configured to selectively couple the redundant load in the first voltage domain to the first power converter; and
a second isolation switch coupled to the second power converter and configured to selectively couple the redundant load in the second voltage domain to the second power converter.

3. The system of claim 2, wherein the third power converter is coupled between the first isolation switch and the second isolation switch.

4. The system of claim 2, wherein the first isolation switch is configured to open upon detection of a fault associated with the first voltage domain, and wherein the redundant load in the first voltage domain is disconnected from the first power converter when the first isolation switch is open.

5. The system of claim 4, wherein the third power converter is configured to convert power from the second voltage domain to the first voltage domain to supply the redundant load in the first voltage domain when the first isolation switch is open.

6. The system of claim 2, wherein the second isolation switch is configured to open upon detection of a fault associated with the second voltage domain, and wherein the redundant load in the second voltage domain is disconnected from the second power converter when the second isolation switch is open.

7. The system of claim 6, wherein the third power converter is configured to convert power from the first voltage domain to the second voltage domain to supply the redundant load in the second voltage domain when the second isolation switch is open.

8. A power conversion system of a vehicle, comprising:
a first power converter configured to generate power in a first voltage domain and supply the power to a primary load in the first voltage domain and to a redundant load in the first voltage domain through a first isolation switch;
a second power converter configured to generate power in a second voltage domain and supply the power to a primary load in the second voltage domain and to a redundant load in the second voltage domain through a second isolation switch; and
a third power converter coupled between the first isolation switch and the second isolation switch,
wherein the first isolation switch is configured to open in response to detecting a fault associated with the first voltage domain and disconnect the redundant load in the first voltage domain from the first power converter,
wherein the second isolation switch is configured to open in response to detecting a fault associated with the second voltage domain and disconnect the redundant load in the second voltage domain from the second power converter, and
wherein the third power converter is configured to:
convert power from the second voltage domain to the first voltage domain and supply power to the redundant load in the first voltage domain when the first isolation switch is open, and
convert power from the first voltage domain to the second voltage domain and supply power to the redundant load in the second voltage domain when the second isolation switch is open.

9. The power conversion system of claim 8, wherein each of the first isolation switch and the second isolation switch includes a fault detection circuit configured to monitor for electrical faults in the first voltage domain and the second voltage domain, respectively.

10. The power conversion system of claim 8, wherein the third power converter is bidirectional and configured to transfer power between the first voltage domain and the second voltage domain to supply one or more of the redundant load in the first voltage domain and the redundant load in the second voltage domain.

11. The power conversion system of claim 8, wherein the first voltage domain and the second voltage domain operate at different voltage levels.

12. The power conversion system of claim 8, further comprising a controller communicatively coupled to the first isolation switch, the second isolation switch and the third power converter, wherein the controller is configured to:
detect a fault in one of the first voltage domain or the second voltage domain;
send a command to one of the first isolation switch or the second isolation switch to open based on the fault; and
activate the third power converter to provide power in one of the first voltage domain or the second voltage domain based at least in part on the fault.

13. A method of converting power in a vehicle, the method comprising:
supplying power from a first power source to a first power converter;
supplying power from a second power source to a second power converter;
converting the power at the first power converter to a first voltage domain;
converting the power at the second power converter to a second voltage domain; and
operating a third power converter coupled between the first voltage domain and the second voltage domain, wherein the third power converter transfers power between the first voltage domain and the second voltage domain based on a fault condition.

14. The method of claim 13, further comprising supplying power from the first power converter to a primary load in the first voltage domain and to a redundant load in the first voltage domain through a first isolation switch.

15. The method of claim 14, further comprising:
opening the first isolation switch upon detecting a fault associated with the first voltage domain; and
disconnecting the redundant load in the first voltage domain from the first power converter.

16. The method of claim 15, further comprising:
when the first isolation switch is open:
converting power from the second voltage domain to the first voltage domain through the third power converter; and
supplying power from the third power converter to the redundant load in the first voltage domain when the first isolation switch is open.

17. The method of claim 13, further comprising supplying power from the second power converter to a primary load in the second voltage domain and to a redundant load in the second voltage domain through a second isolation switch.

18. The method of claim 17, further comprising:
opening the second isolation switch upon detecting a fault associated with the second voltage domain; and
disconnecting the redundant load in the second voltage domain from the second power converter.

19. The method of claim 18, further comprising:
when the second isolation switch is open:
converting power from the first voltage domain to the second voltage domain through the third power converter; and
supplying power from the third power converter to the redundant load in the second voltage domain.

20. The method of claim 13, further comprising providing bidirectional power transfer between the first voltage domain and the second voltage domain via the third power converter.
